(19) United States
(12) Patent Application Publication
(10) Pub. No.: US 2011/0192683 A1
(43) Pub. Date: Aug. 11, 2011

(54) ELEVATOR SYSTEM WITH SUPPORT MEANS STATE DETECTING DEVICE AND METHOD FOR DETECTING A STATE OF A SUPPORT MEANS

(76) Inventors: Karl Weinberger, Immensee (CH); Hans Kocher, Udligenswil (CH)

(21) Appl. No.: 12/672,629

(22) PCT Filed: Aug. 4, 2008
(86) PCT No.: PCT/EP08/60208

§ 371 Date: Feb. 8, 2010

(30) Foreign Application Priority Data
Aug. 17, 2007 (EP) 07114522.1

(51) Int. Cl. B66B 7/12; B66B 7/06; B66B 3/00

(52) U.S. Cl. 187/254; 187/393

(57) ABSTRACT

The invention relates to an elevator system having an elevator car, a load carrier for holding and/or moving the elevator car, and a detector device for detecting a condition of the load carrier, the detector device having an ultrasonic emitter for generating and coupling ultrasonic waves into the load carrier and for generating ultrasonic waves in the load carrier, and an ultrasonic receiver for detecting ultrasonic waves of the load carrier.

### FIELD OF THE INVENTION

The present invention relates to an elevator system with an elevator car, a support means and a detecting device for detecting a state of the support means, and to a method for detecting this state.

### BACKGROUND OF THE INVENTION

An elevator car is moved in an elevator shaft or along free-standing guide devices by a force transmission means, i.e. raised and lowered. In order in that case to reduce the necessary lifting force, partial compensation for the weight force of the elevator car can be provided by a counterweight which is coupled with the elevator car by way of a coupling means. Force transmission means and coupling means can be of separate construction. The traction force for raising and lowering the elevator car is, however, preferably transmitted by way of the same transmission means by which the elevator car is also coupled with the counterweight. Not only such special force transmission means or coupling means, but also such transmission means serving for both holding and moving an elevator car are uniformly termed support means in the following.

Plain steel cables are conventionally used as support means in elevator systems. The support means are in use subject to a certain degree of wear. In addition, for example, load peaks, vibrations or mechanical or thermal loads can lead to damage and thus to weakening of the support means. In order to prevent failure of the support means, the state of the support means has to be detected and checked non-destructively. For this purpose, for example, a visual check is known, which, however, is both costly and unreliable.

For checking steel cables it is known from the specification JP09290973A to detect the magnetic flux of the steel cable in order to recognize fracture of individual strands. However, this method, for example by magnetic fields which are produced by a drive motor of the elevator system, is susceptible to failure and therefore inaccurate. The checking of support means in which only a small magnetic flux arises, thus particularly support means with non-metallic components is possible by this method only with difficulty.

It is known from the specification WO 03043922A1 to use, as support means, one or more support belts with tensile carriers for transmission of longitudinal forces, which carriers are arranged in a support belt body and encased by this. This excludes visual checking of the tensile carriers. Static charges, metallic abrasion on the support belt body and the like can change the magnetic flux and thus impair checking of the support means and of, in particular, the tensile carriers which substantially transmit the longitudinal forces. In the case of thin tensile carriers only a comparatively small magnetic flux occurs, which can be detected reliably and precisely only with difficulty. If the tensile carriers are of non-metallic material, checking by measurement of the magnetic flux is excluded.

### SUMMARY OF THE INVENTION

It is therefore the object of the present invention to take on an elevator system with a detecting device or a method for simple and reliable detection of a state of the support means.

An elevator system according to the present invention comprises an elevator car and a support means for holding and/or moving the elevator car. The support means can be guided from a first cable fixing point over one or more deflecting elements, particularly deflecting rollers, and at least one drive roller to a second cable fixing point, wherein the elevator car and preferably a counterweight are fastened to the deflecting elements in such a manner that the elevator car and the counterweight are raised and lowered in opposite sense by a rotation of the drive rollers, which are connected with the drive motor of the elevator car and are looped around at least partly by the support means. Equally, the support means can be fixed at one end also to the elevator car and also by another end to the counterweight.

In a preferred embodiment of the present invention this support means comprises one or more support belts with tensile carriers which substantially transmit the longitudinal forces in the support means and which are arranged at least partly, advantageously entirely, in a support belt body. The tensile carriers can in that case be constructed from singly or multiply stranded strands of steel or aramide, but can also be made from another material. The support belt body can consist of a synthetic material, a fabric or the like.

According to the invention an elevator system further comprises a detecting device for detecting a state of the support means, which comprises an ultrasonic transmitter for generating and coupling ultrasonic waves into the support means or for generating ultrasonic waves in the support means as well as an ultrasonic receiver for detecting ultrasonic waves of the support means.

Ultrasonic waves allow a simple detection of a state of the support means. For example, a material state, particularly a wear or damage state, of the support means can be detected by these ultrasonic waves. Thus, the material thickness and thereby the wear state of the support means can be detected by way of the transit times which the ultrasonic waves require in the support means. Fault locations and cracks in the material change the ultrasonic waves conducted through or reflected in the support means and thus allow detection of the damage state thereof. In addition, a strength state of the support means can be determined from the number, size and distribution of such cracks or fault locations and/or the material thickness.

Tensions acting on the support means, particularly normal tensions in longitudinal direction of the support means, lead to deformation thereof and thus similarly change the transmission characteristics thereof for ultrasonic waves. A tension state of the support means, for example, can therefore also be detected by way of the ultrasonic waves.

If a wear and/or damage state exceeds predetermined limit values and/or a strength state falls below permissible minimum values then the support means has to be changed. The ultrasonic waves thus also make possible detection of a change state of the support means, in detail assessment whether or not the support means has to be changed. If a wear, damage and/or strength state approaches the predetermined limit values or minimum values without already reaching these or exceeding or falling below these, this is an indication that the support means has to be subjected to a more precise examination, for example by means of X-rays, destructive material checking or the like. Thus, an inspection state of the support means can also be ascertained on the basis of the ultrasonic waves, in detail whether or not the support means has to be subjected to a more precise inspection.

The ultrasonic waves can equally—as longitudinal or transversal waves, as surface waves, shear waves or volume waves—be coupled directly into the support means or generated directly in the support means. In that case the ultrasonic waves can equally be present as continuous sound or impulse sound. Whereas continuous sound enables a simpler drive control of the ultrasonic transmitter, impulse sound reduces the energy required for generation of the ultrasonic waves and decreases the mutual influencing of coupled-in and reflected ultrasonic waves.

According to a preferred embodiment of the present invention the coupling-in or the generation of the ultrasonic waves takes place not directly in the support means, but indirectly in an axle of a deflecting or drive roller which is at least partly looped around by the support means. In that case ultrasonic waves propagating in the longitudinal direction of the axle of the deflecting or drive roller and/or ultrasonic waves propagating perpendicularly to the longitudinal direction of the axle of the deflecting or drive roller can be coupled into the axle of the deflecting or drive roller or generated in the axle of the deflecting or drive roller. In both cases the ultrasonic receiver is appropriately arranged in order to detect ultrasonic waves which propagate transversely to the longitudinal direction of the support means in the support means and/or in the axle of the deflecting or drive roller.

According to a preferred embodiment of the present invention the ultrasonic transmitter and the ultrasonic receiver each comprise at least one respective piezo crystal, which directly or indirectly couples to at least one surface of the support means. The drive control of the ultrasonic transmitter takes place through application of an electrical voltage which changes over time and which deforms the piezo crystal. In that case the piezo crystal imposes on the support means ultrasonic waves which are passed on as mechanical waves on the surface thereof or in the interior thereof. The use of a piezoelectric transducer enables a simple, precise coupling in even of more complex ultrasonic wave patterns. Correspondingly, the ultrasonic receiver also comprises a piezo crystal which directly or indirectly couples to at least one surface of the support means. Ultrasonic waves in the support means thus produce a mechanical deformation of the piezo crystal, which thereupon reacts with an electrical voltage which can be tapped. The voltage change can be fed to an evaluating device which thus detects the ultrasonic waves. Here the piezo crystals allow a simple and precise detection of ultrasonic waves. In addition, the use of an ultrasonic transmitter or ultrasonic receiver on the basis of a piezoelectric transducer allows a simple and reliable checking of the support means, which, in particular, is not disturbed by magnetic fields such as can be caused by, for example, a drive motor or a control of the elevator system. In addition, they are also not impaired by static charges or the like. The checking of support means components in which only a low magnetic flux occurs is possible by them.

According to a further preferred embodiment of the present invention the ultrasonic transmitter and the ultrasonic receiver each comprise at least one electromagnetic-acoustic ultrasonic transducer (EMAT). An electromagnetic-acoustic ultrasonic transducer produces ultrasonic waves by Lorentz force and/or the magnetorestrictive effect in a solid body, so that coupling of ultrasonic waves into the solid body is not necessary. The solid body can be the support means itself and/or an axle of a deflecting or drive roller, which is looped around at least partly by the support means. The electromagnetic-acoustic ultrasonic transducer is arranged at a small spacing from the solid body. The drive control of the ultrasonic transmitter takes place, for example, by an electric current induced by an eddy current coil. Correspondingly, the ultrasonic receiver also comprises an electromagnetic-acoustic ultrasonic transducer so that decoupling of the ultrasonic waves from the solid body is not necessary. The ultrasonic waves thus detected by the ultrasonic receiver can be tapped as electric current.

The ultrasonic waves can be coupled into the support means or generated in the support means to propagate in the support means in the longitudinal direction of the support means. This is possible preferably at fixing points of the support means at which the support means is inertially fastened. If, for example, the support means is inertially fastened at each of its two ends and guided therebetween over deflecting and drive rollers then the ultrasonic transmitter can be arranged at one of the two ends of the support means in such a manner that it couples ultrasonic waves into or generates ultrasonic waves in the support means to propagate in the longitudinal direction thereof, wherein the ultrasonic receiver is arranged at the other one of the two ends of the support means in such a manner that it detects ultrasonic waves of the support means propagating in the support means in the longitudinal direction of the support means. Alternatively, the ultrasonic receiver can also be arranged together with the ultrasonic transmitter at the same end of the support means and detect reflected ultrasonic waves of the support means propagating in the support means in the longitudinal direction of the support means.

Additionally or alternatively the ultrasonic transmitter can also couple into the support means, or generate in the support means, ultrasonic waves which propagate in the support means in the width direction of the support means. This can preferably take place in regions in which the support means is guided. Accordingly, an ultrasonic receiver detects these ultrasonic waves, which propagate in the support means in the width direction of the support means, of the support means.

According to a further embodiment of the present invention the transmission of the ultrasonic waves, i.e. the conducting thereof in the support means, is detected. Disturbance locations, particularly fault locations or cracks, in the material cause, for example, a reduction in energy of the passed-on ultrasound and can therefore be detected by comparison of the ultrasonic wave energy, which is coupled into the support means or generated in the support means, and the detected ultrasonic wave energy of the support means.

According to another embodiment of the present invention reflected ultrasonic waves of the support means are detected. Ultrasonic waves are at least partly reflected at the boundary surfaces of the support means, particularly at the surfaces thereof. However, ultrasonic waves are also at least partly reflected at fault locations of the support means. Through comparison of the transit times of the ultrasonic waves coupled into the support means or generated in the support means and reflected in the support means the size and position of such fault locations can thus be ascertained.

The frequencies of the ultrasonic waves also displace due to such fault locations. Thus, conclusions about fault locations can also be drawn from frequency differences between the ultrasonic waves, which are coupled into the support means or generated in the support means, and detected ultrasonic waves of the support means.

The detection of the transit time, the energy decrease or a frequency difference between ultrasonic waves, which are coupled into the support means or generated in the support means, and detected ultrasonic waves of the support means in an evaluating unit also allows thickness measurement of the support means and thus a check of the wear state thereof, because ultrasonic waves transmitted in a thinner support means require a smaller transit time and lose less energy. In addition, the frequency difference between ultrasonic waves coupled into the support means or generated in the support means and reflected ultrasonic waves of the support means change in dependence on the material thickness.

The tension and deformation state of the support means influences the transmission characteristics thereof for ultrasonic waves. Thus, the ultrasonic waves detected by the ultrasonic receiver change in dependence on the load acting on the support means. This makes it possible to detect the load state of the support means on the basis of the ultrasonic waves, in particular to thus recognize a belt tension. In order conversely to eliminate load-dependent influences on the detection of, for example, a material state of the support means an equilibrium strand of the support means is checked by means of the ultrasonic waves in another form of embodiment of the present invention, i.e. ultrasonic transmitter and ultrasonic receiver are arranged at an equilibrium strand, the tension state of which does not change or changes only slightly.

The aforesaid embodiments can also be combined. For this purpose, for example, a first ultrasonic receiver can detect ultrasonic waves which are passed on by the support means and a second ultrasonic receiver can detect, simultaneously or in alternation, ultrasonic waves reflected in the support means.

The coupling in to the support means or the generation in the support means and/or the detection of the ultrasonic waves of the support means can be locally closely confined. It is possible with such a detecting device to ascertain the state of the support means at, for example, significant, for example especially loaded, locations. Alternatively, ultrasonic waves or ultrasonic receivers, which cover only a closely limited range, can be moved manually or automatically over larger regions of the support means and thus sequentially detect the state of the support means in this larger region. Preferably, ultrasonic transmitters and ultrasonic receivers, however, cover a larger region, i.e. ultrasonic waves are coupled into the support means or generated in the support means and conducted over a larger region of the support means, preferably over the complete width or the complete length of the support means, before the ultrasonic waves of the support means are detected. Mixed forms are also possible in the manner that an ultrasonic receiver receives the ultrasonic waves which are coupled into the support means or generated in the support means by different ultrasonic transmitters or, conversely, that the ultrasonic waves coupled into the support means or generated in the support means by an ultrasonic transmitter are detected by several spatially distributed ultrasonic receivers.

A detecting device for detection of the state of the support means according to the present invention can be constructed as a mobile apparatus with a movable ultrasonic probe, in which ultrasonic transmitter and ultrasonic receiver are integrated. Such instruments are, for example, known from medical diagnostics or non-destructive material checking in situ. For preference, however, the ultrasonic transmitter and/or the ultrasonic receiver is or are arranged in stationary position at the support means so as to ensure an unchanging positioning relative to the support means and thus to improve detection accuracy. Preferably, the ultrasonic transmitter and/or the ultrasonic receiver are in that case so arranged that on movement of the elevator car a part of the support means runs past the ultrasonic transmitter or ultrasonic receiver and thus enables a section-by-section checking of the support means.

Particularly in the case of a detecting device arranged in stationary position at the support means this comprises, in a preferred form of embodiment, a transmitting unit for transmission of at least one evaluation signal of the evaluating device, in which the ultrasonic waves detected by the ultrasonic receiver are evaluated, at a receiver which can be arranged outside an elevator shaft to be mobile, for example in a hand appliance for maintenance personnel, or in stationary position, for example at a central station of the elevator system. A check of the support means can thus take place without maintenance personnel having to climb into the elevator shaft.

The detecting device can continuously detect the state of the support means. For preference, however, the check is carried out only at predetermined time intervals and the result transmitted via the transmitting device. Additionally or alternatively the detecting device can also be activated by remote control in order to carry out a check depending on the respective need. For this purpose the transmitting device comprises, according to a preferred embodiment of the present invention, a receiver for reception of at least one trigger signal, which, for example, is transmitted from a maintenance person by way of a mobile hand appliance or from the central station. If the receiver of the transmitting device receives a trigger signal, then the ultrasonic transmitter couples ultrasonic waves into the support means or generates ultrasonic waves in the support means, which are detected by the ultrasonic receiver and evaluated by the evaluating device. At least one corresponding evaluating signal is then transmitted by the transmitting device to the mobile receiver or the central station. This enables remotely controlled checking of the support means.

### DESCRIPTION OF THE DRAWINGS

Further objects, advantages and features of the present invention are evident from the following described examples of embodiment. For this purpose, partly schematically:

FIG. 1 shows an elevator system according to an embodiment of the present invention;

FIG. 2 shows a first form of embodiment of a support means of the elevator system according to FIG. 1, in perspective partial section;

FIG. 3 shows a second form of embodiment of a support means of the elevator system according to FIG. 1, in cross-section;

FIG. 4 shows a third form of embodiment of a support means of the elevator system according to FIG. 1, in cross-section;

FIG. 5 shows a fourth form of embodiment of a support means of the elevator system according to FIG. 1, in cross-section;

FIG. 6 shows a fifth form of embodiment of a support means of the elevator system according to FIG. 1, in cross-section;

FIG. 7 shows a sixth form of embodiment of a support means of the elevator system according to FIG. 1, in cross-section;

FIG. 8 shows a first form of embodiment of a detecting device for detecting a state of a support means of the elevator system according to FIG. 1, wherein ultrasonic waves are coupled in over the entire length of the support means;

FIG. 9 shows a second form of embodiment of a detecting device for detecting a state of a support means of the elevator system according to FIG. 1, wherein ultrasonic waves are coupled in in longitudinal direction of the support means;

FIG. 10 shows a third form of embodiment of a detecting device for detecting a state of a support means of the elevator system according to FIG. 1, wherein ultrasonic waves are coupled in in longitudinal direction of the support means;

FIG. 11 shows a fourth form of embodiment of a detecting device for detecting a state of a support means of the elevator system according to FIG. 1, wherein ultrasonic waves are coupled in in longitudinal direction of the support means;

FIG. 12 shows a fifth form of embodiment of a detecting device for detecting a state of a support means of the elevator system according to FIG. 1, wherein ultrasonic waves are coupled in over the entire width of the support means;

FIG. 13 shows a sixth form of embodiment of a detecting device for detecting a state of a support means of the elevator system according to FIG. 1, wherein ultrasonic waves are coupled in in longitudinal and width direction of the support means;

FIG. 14 shows a seventh form of embodiment of a detecting device for detecting a state of a support means of the elevator system according to FIG. 1, wherein ultrasonic waves are coupled in in longitudinal and width direction of the support means;

FIG. 15 shows an eighth form of embodiment of a detecting device for detecting a state of a support means of the elevator system according to FIG. 1, wherein ultrasonic waves are coupled into the support means and reflected ultrasonic waves are detected;

FIG. 16 shows a ninth form of embodiment of a detecting device for detecting a state of a support means of the elevator system according to FIG. 1, wherein ultrasonic waves are coupled into the support means and reflected ultrasonic waves are detected;

FIG. 17 shows a tenth form of embodiment of a detecting device for detecting a state of a support means of the elevator system according to FIG. 1, wherein ultrasonic waves are coupled into the support means by way of a drive roller;

FIG. 18 shows an eleventh form of embodiment of a detecting device for detecting a state of a support means of the elevator system according to FIG. 1, wherein ultrasonic waves are coupled into the support means by way of a deflecting roller;

FIG. 19 shows a twelfth form of embodiment of a detecting device for detecting a state of a support means of the elevator system according to FIG. 1, wherein ultrasonic waves are coupled into the support means by way of a deflecting roller; and

FIG. 20 shows a thirteenth form of embodiment of a detecting device for detecting a state of a support means of the elevator system according to FIG. 1, with trigger signal and evaluating signal of a state detection.

### DESCRIPTION OF THE PREFERRED EMBODIMENT

An elevator system according to an embodiment of the present invention comprises a support means 2, which is illustrated in more detail in FIGS. 2 to 7 in several forms of embodiment, in the form of a support belt with at least one tensile carrier 2.1 for transmission of longitudinal forces, which carriers are arranged in a support belt body 2.2 of synthetic material.

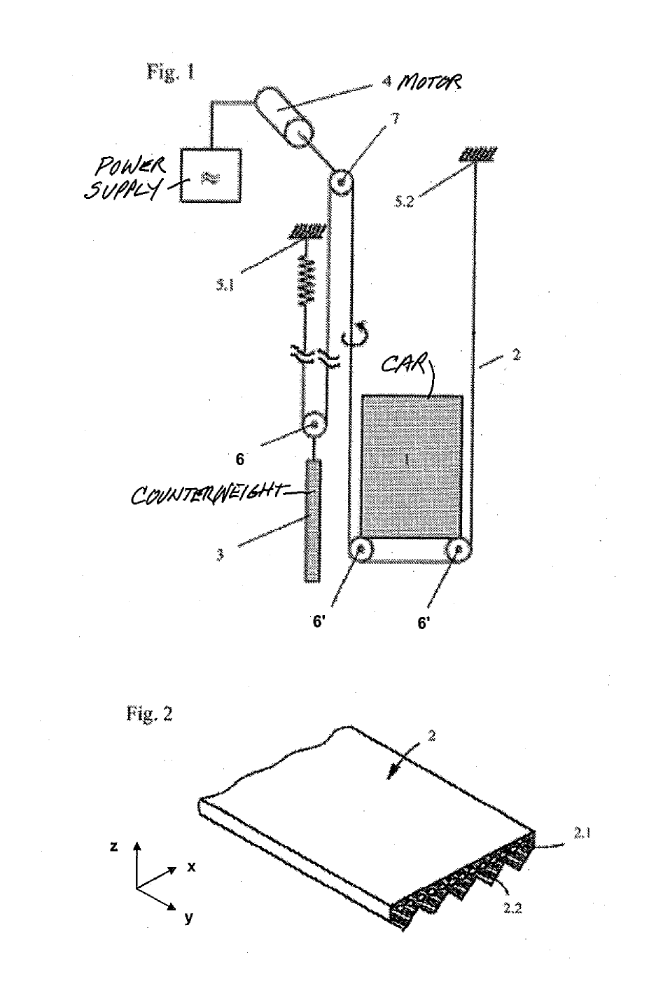

As illustrated in FIG. 1, the support means 2 is inertially fastened at a first fixing point 5.1, wherein in order to provide compensation for load shocks a resilient suspension, indicated by a spring, can be provided. From there the support means 2 is guided around a first deflecting roller 6 at which a counterweight 3 hangs. From there it is led over at least one drive roller 7 on to two further deflecting rollers 6′ and inertially fixed by its other end at a second fixing point 5.2. An elevator car 1 is fastened to this further deflecting roller 6′. Whereas the support means 2 loops around the first deflecting roller 6 and the drive roller 7 by an angle of about 180°, the support means 2 loops around the further deflecting rollers 6′ only by an angle of about 90°. Further details with respect to this 2:1 suspension of the support means 2 are disclosed in the specification WO 03043922A1. Other forms of embodiment of the suspension of the support means 2 are possible with knowledge of the present invention. Thus, a 1:1 suspension (not illustrated) of the support means as disclosed in more detail in the specification WO 03043926A1 is also possible in which the first and second fixing points of the support means are fastened to the counterweight and the elevator car.

A drive unit 4 can impose a torque on the deflecting roller 7, which by friction couple transmits corresponding longitudinal forces to the support means 2, which loops around the drive roller 7 with friction couple. Through corresponding rotation of the drive roller 7 by means of the drive unit 4, the elevator car 1 and the counterweight 3 can thus be raised and lowered in opposite sense.

For better orientation, FIGS. 2 to 20 are provided with xyz co-ordinates. In that case the width of the support means 2 extends in the x direction, the height of the support means 2 takes place in the z direction and the length of the support means 2 runs in the y direction. Correspondingly, the sides of the support means 2 extending in the x direction and the y direction are termed wide sides and those in the y direction and the z direction are termed longitudinal sides.

In the forms of embodiment according to FIGS. 2 to 5 the synthetic material body 2.2 is constructed on at least one wide side as a wedge-ribbed belt. The wide side has wedge rib surfaces which extend at different angles of 45° or 30° or also 0° with respect to the xy plane. In the forms of embodiment according to FIGS. 6 and 7 the synthetic material body 2.2 is executed to be flat or sinusoidally waved on its wide sides. The flat wide side lies to the full scope in the xy plane and the sinusoidally waved wide side consequently extends the radius in the x direction and in the y direction. In addition, the synthetic material body 2.2 of the form of embodiment according to FIG. 1 is executed to be flat on a wide side and lies to the full scope in the xy plane. Correspondingly, the flat longitudinal sides of the synthetic material body 2.2 of the forms of embodiment according to FIGS. 2 to 5 lie to the full scope in the yz plane, whilst the sinusoidally waved longitudinal sides of the synthetic material body 2.2 of the forms of embodiment according to FIGS. 6 and 7 consequently extend the radius in the y direction and the z direction. With knowledge of the present invention the expert can obviously also use further forms of embodiment (not shown here) of synthetic material bodies, for example different angles and radii of the synthetic material body can be used and a synthetic material body with rectangular, quadrangular or round cross-section can also be used. The synthetic material body 2.1 consists at least partly of polyurethane or EPDM (ethylene propylene diene monomer) and optionally equally partly of a fabric on a Nylon base. The use of other synthetic materials is obviously equally possible.

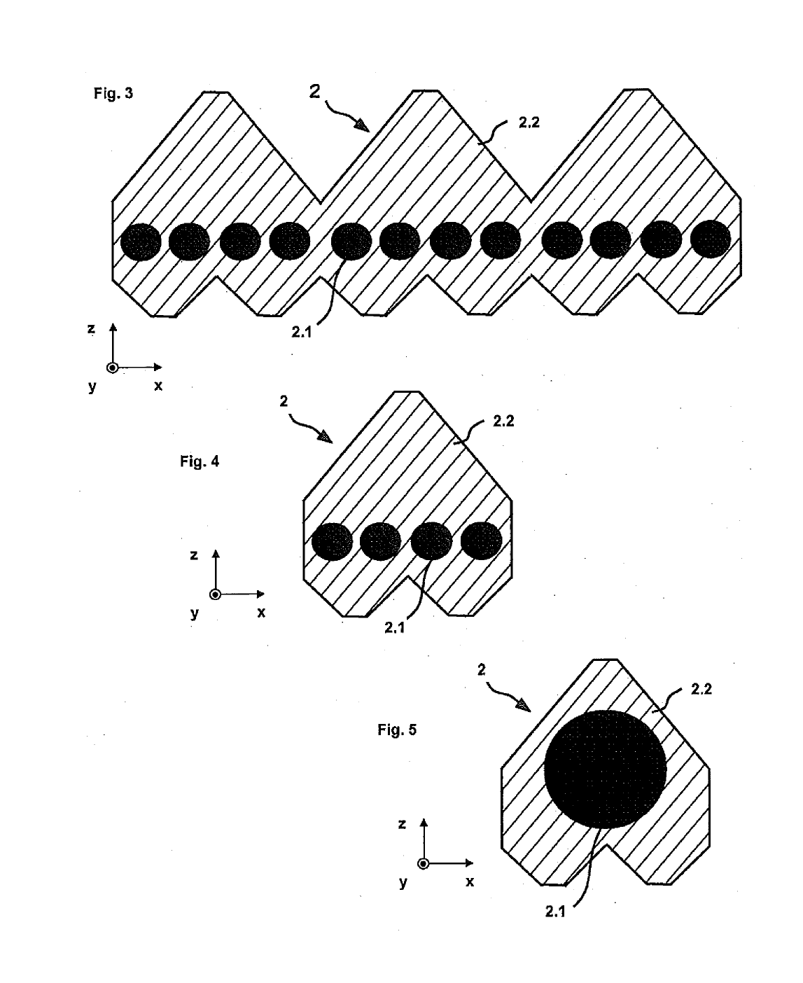

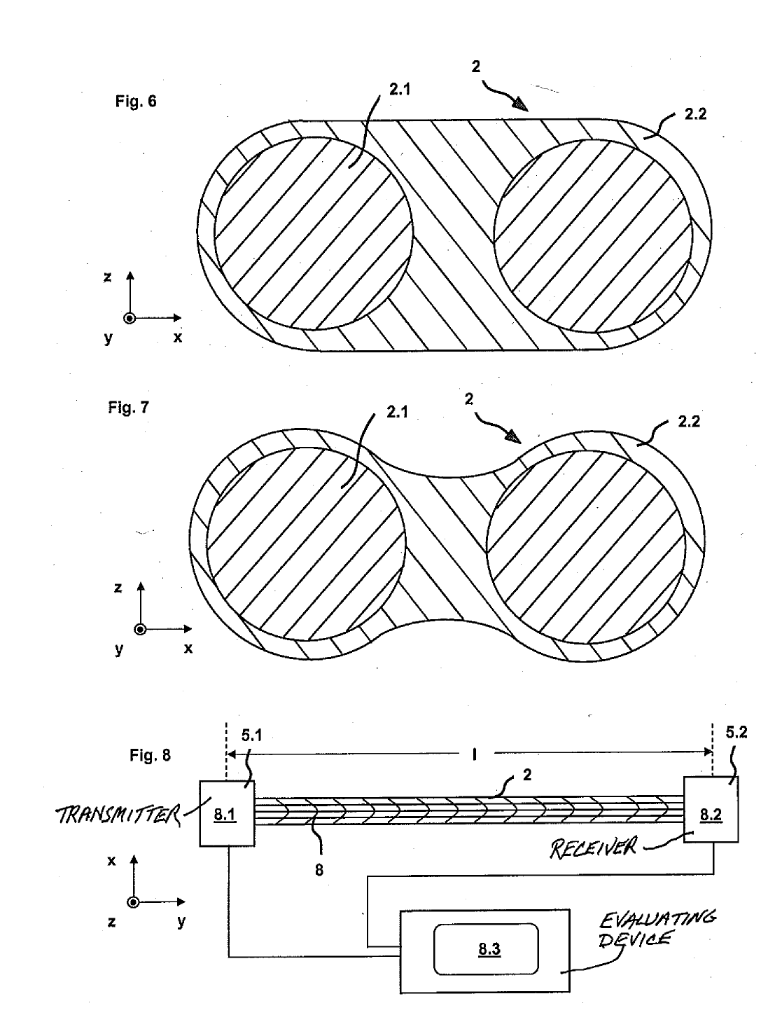

The synthetic material body 2.2 encloses at least one tensile carrier 2.1 which is arranged in a neutral phase of the support means 2. The number and diameter of the tensile carriers 2.1 per support means 2 vary. Whereas in the forms of embodiment according to FIGS. 2 and 3 thirteen or twelve tensile carriers 2.1 are arranged in the synthetic material body 2.2 of the support means 2, the support means 2 of the form of embodiment according to FIG. 4 has only four tensile carriers 2.1, in that according to FIG. 5 only one tensile carrier 2.1 and in that according to FIGS. 6 and 7 two tensile carriers 2.1 in the synthetic material body 2.2. The tensile carriers 2.1 consist of metal, such as steel, or of synthetic material, such as aramide. The diameters of the tensile carriers 2.1 can be 1.5 to 12 millimeters. Each tensile carrier consists of several singly or multiply stranded strands and a plurality of metal wires or synthetic material filaments. Further details with respect to tensile carriers are known from the specifications EP 1555234 A1 and EP 0672781A1.

The thickness-to-width ratio of the support means 2 similarly substantially varies. Accordingly, the support means 2 in the forms of embodiment according to FIGS. 3, 6 and 7 are wider than thick, whereas the support means 2 of the forms of embodiment according to FIGS. 4 and 5 are just as thick as wide or thicker than wide.

The deflecting rollers 6, 6′ and the drive roller 7 have corresponding counter-profiles (not illustrated) in which the wedge ribs of the support means body 2.2 engage. This increases the traction capability of the drive roller 7 and improves the guidance of the drive means 2 on the deflecting rollers 6, 6′ or the drive rollers 7. For this purpose the support means 2 is turned through 180° about its longitudinal axis between the drive rollers 7 and the further deflecting rollers 6′, which is illustrated by a curved arrow. Further details with respect to this form of embodiment are disclosed in the specification EP 1550629 A1.

The detecting device for detecting a state of a support means 2 of the elevator system is explained in detail in several forms of embodiment according to FIGS. 8 to 20. The deflecting device comprises an ultrasonic transmitter 8.1, an ultrasonic receiver 8.2 and an evaluating device 8.3. For generation or reception of ultrasound not only the ultrasonic transmitter 8.1, but also the ultrasonic receiver 8.2 each comprise, for example, a piezoelectric transducer and/or an electromagnetic-acoustic ultrasonic transducer. In the forms of embodiment according to FIGS. 8 to 16 and 20 the ultrasonic transmitter 8.1 and the ultrasonic receiver 8.2 are arranged directly at the support means 2 and in the forms of embodiment according to FIGS. 17 to 19 the ultrasonic transmitter 8.1 and the ultrasonic receiver 8.2 are arranged indirectly at the support means 2.

In the case of piezoelectric transducers an electric voltage (for example a sinusoidal alternating voltage) is imposed on the piezo crystal of the ultrasonic transmitter 8.1 so that this piezo crystal mechanically deforms. The ultrasonic transmitter 8.1 and the support means 2 are mechanically coupled together so that the mechanical deformation of the piezo crystal couples into the support means 2 as ultrasonic waves 8. The ultrasonic waves 8 run through the support means 2 and pass to the piezo crystal of the ultrasonic receiver 8.2, which mechanically deforms in analogous mode and manner, which can be tapped as an electric voltage.

In the electromagnetic-acoustic ultrasonic converter, ultrasonic waves are generated by the Lorentz force and/or the magnetorestrictive effect in a solid body, such as the support means 2 or an axle of a deflecting roller 6, 6′ or a drive roller 7, which is looped around at least partly by the support means. The drive control of the ultrasonic transmitter is carried out, for example, by an electric current, which is induced by an eddy current coil and the ultrasonic waves detected by the ultrasonic receiver can be tapped as an electric current. Whereas in the case of piezo electric converters the ultrasonic waves 8 are generated in the piezo crystal of the ultrasonic transmitter 8.1 and coupled by way of a mechanical coupling into the support means 2, the electromagnetic-acoustic ultrasonic converter generates the ultrasonic waves directly in the support means 2 so that a mechanical coupling is not necessary. For this purpose the electromagnetic-acoustic ultrasonic converter is arranged at a small spacing from the solid body.

The ultrasonic waves can equally be coupled into the support means 2 or generated in the support means 2 as longitudinal or transversal waves, as surface waves, shear waves or volume waves. In that case they can be equally coupled in or generated as continuous sound or impulse sound. Whereas coupling in as continuous sound enables simpler drive control of the ultrasonic transmitter 8.1, the coupling in as impulse sound reduces the energy required for generation of the ultrasonic waves and reduces the mutual influencing of coupled-in ultrasonic waves and reflected ultrasonic waves 8′. A typical pulse repetition rate is 100 Hz. For good coupling in or for good detection of the ultrasonic waves 8, 8′, the ultrasonic transmitter 8.1 and the ultrasonic receiver 8.2 are mechanically firmly clamped against the support means 2. For example, the ultrasonic transmitter 8.1 generates ultrasonic waves 8 in the frequency range of 20 kHz to 1 GHz, which are coupled into the support means 2 or generated in the support means 2. An advantageous frequency of ultrasonic waves 8, 8′ is 75 kHz, in which separated steel wires of a support means 2 in the form of embodiment according to FIG. 2 are detected not only in longitudinal ultrasonic transmission, but also in width ultrasonic transmission.

Ultrasonic transmitter 8.1 and ultrasonic receiver 8.2 are connected by way of signal lines with an evaluating device 8.3, which compares the imposed electric voltage of the piezoelectric converter or the induced electric current of the electromagnetic-acoustic ultrasonic converter with the tapped electric voltage of the piezoelectric converter or with the tapped electric current of the electromagnetic-acoustic converter. The at least one output signal of the ultrasonic receiver 8.2 is amplified by suitable means and prepared and can be represented on a display screen of an oscilloscope and can be printed out by a printer and stored in a digital memory as digital files.

The ultrasonic waves 8 are partly absorbed or reflected at disturbance locations, for example fault locations in the material or cracks, which form due to, for example, production faults, load peaks or mechanical or thermal loads, in the support means 2. The energy of the transmitted ultrasonic waves 8 thus reduces. Through comparison of the energy of the coupled-in and the detected ultrasonic waves 8, 8′ it is thus possible to detect a material state, particularly a damage state, of the support means 2. For this purpose the ultrasonic transmitter 8.1 and the ultrasonic receiver 8.2 are activated at regular time intervals and the energy decrease between coupled-in and detected ultrasonic waves 8, 8′ for the different measurements is stored. With increasing disturbance locations the energy reduction rises. If this energy decrease approaches a predetermined limit value, which can, for example, be determined experimentally, this indicates that the support means 2 has a specific damage state and therefore should be checked more accurately. In this case the evaluating device 8.3 transmits at least one evaluation signal to a central station and thus automatically requires a more accurate checking of the support means 2, for example by means of X-ray radiation.

In addition, the support means 2 stretches depending on the respective loading of the elevator car. Accordingly, there is a change in the transit time of the ultrasonic waves 8 needed by these waves to pass from the ultrasonic transmitter 8.1 to the ultrasonic receiver 8.2. Through comparison of the time instants between coupling-in of the ultrasonic waves 8 and the detection thereof it is thus possible to detect the stretching of the support means 2 and thereby its tension state.

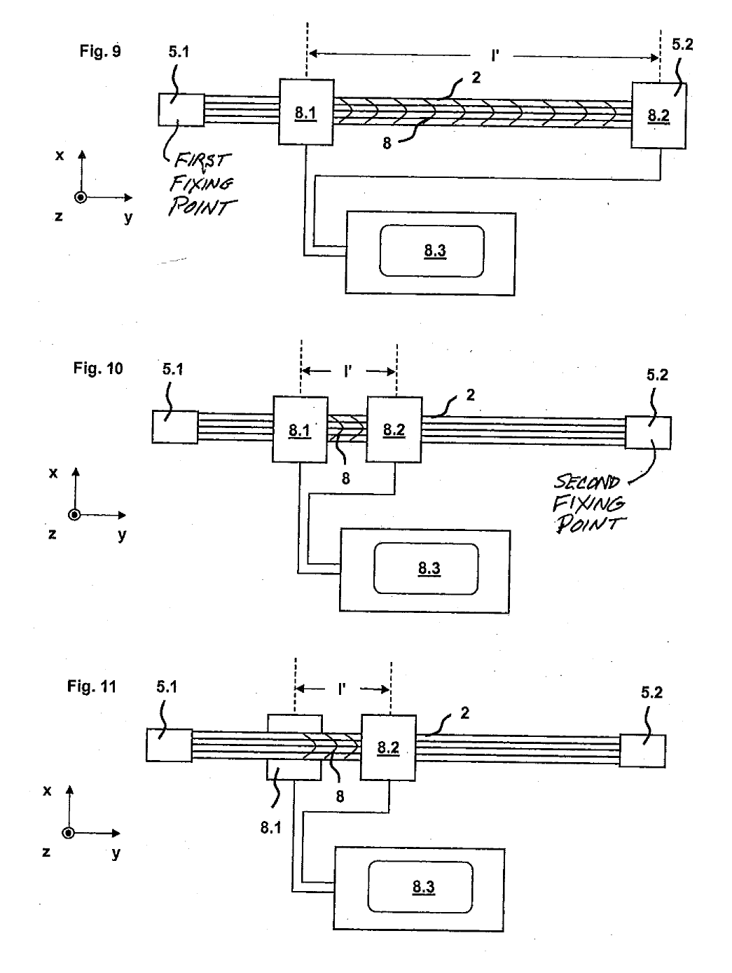

In the forms of embodiment according to FIGS. 8 to 11, ultrasonic transmitter 8.1 and ultrasonic receiver 8.2 are arranged at the support means 2 and the ultrasonic waves 8 run through in longitudinal direction (y direction) a length l, l′ of the support means 2. In that case an entire-length ultrasonic transmission or a part-length ultrasonic transmission of the support means can take place. With an entire-length ultrasonic transmission according to FIG. 8 the entire length I of the support means 2 between the two fixing points 5.1, 5.2 is acted on by ultrasonic waves 8. In the case of five-storey building and an elevator system with 2:1 suspension of the support means 2 the entire length I of the support means 2 is, for example, 36 meters. With a part-length ultrasonic transmission according to FIGS. 9 to 11 only a part length l′ of the support means 2 is acted on by ultrasonic waves 8. The part length of the support means 2 can be a few centimeters or also several meters long. In FIG. 8 the ultrasonic transmitter 8.1 and the ultrasonic receiver 8.2 are mounted at the end at the support means 2. For example, the ultrasonic transmitter 8.1 is arranged in stationary position at the first fixing point 5.1 and the ultrasonic receiver 8.2 is arranged in stationary position at the second fixing point 5.2. In the form of embodiment according to FIG. 9 only the ultrasonic receiver 8.2 is arranged in stationary position at the second fixing point 5.2 and the ultrasonic transmitter 8.1 is arranged on a wide side of the support means 2 to be mobile. FIGS. 10 and 11 show forms of embodiment where the ultrasonic transmitter 8.1 and the ultrasonic receiver 8.2 are arranged to be mobile on the same wide sides (FIG. 10) or on different wide sides (FIG. 11) of the support means 2. With knowledge of the present invention the expert can obviously realise further forms of embodiment (not illustrated). Thus, in a modification of the forms of embodiment according to FIG. 9 the expert can arrange the ultrasonic transmitter 8.1 in a stationary position at the first fixing point 5.1 and the ultrasonic receiver 8.2 on a wide side at the support means 2 to mobile.

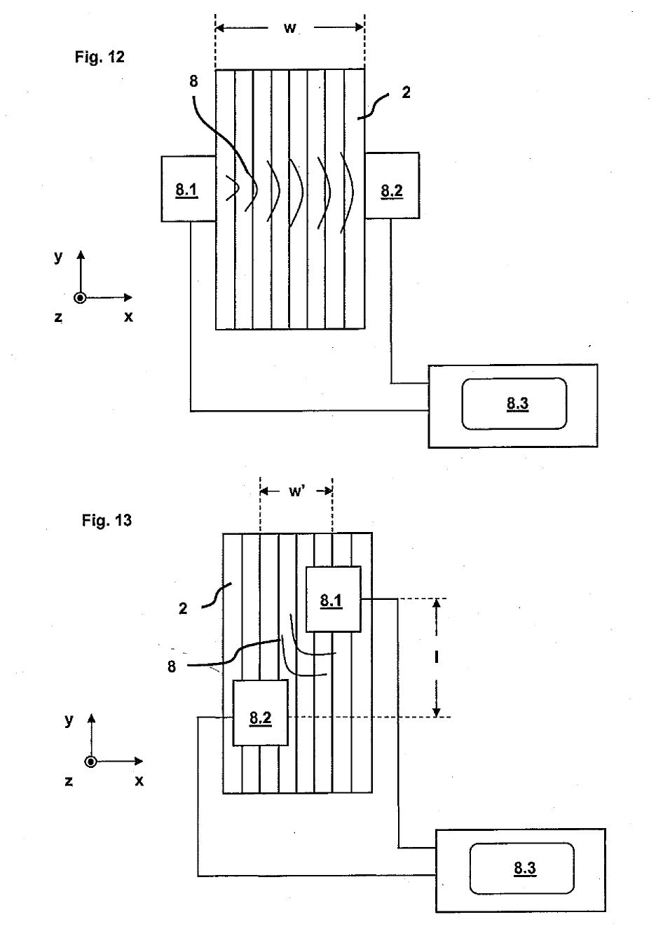

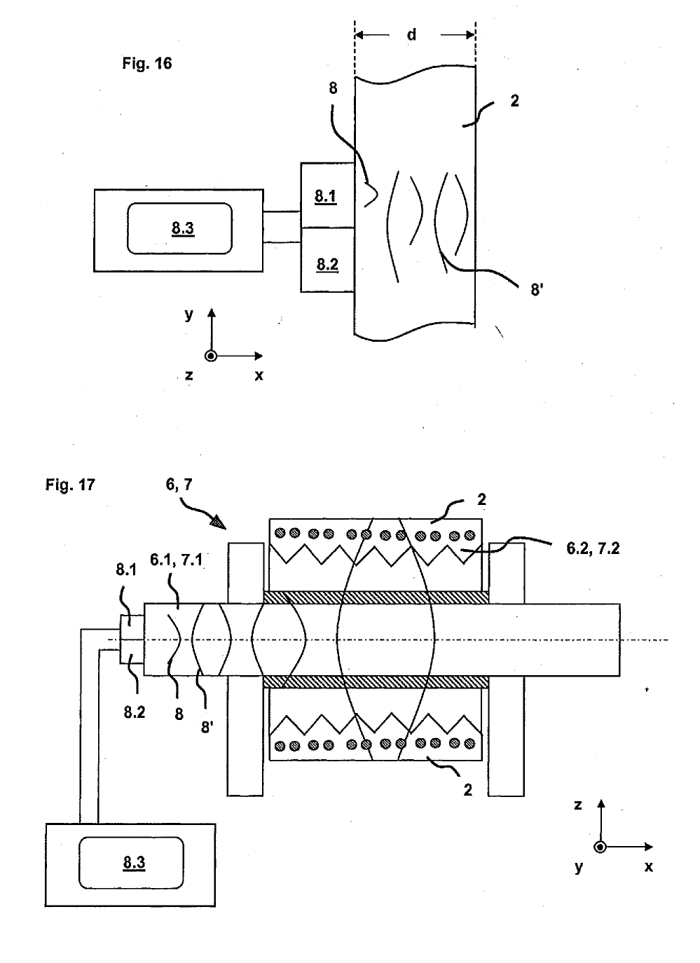

In the forms of embodiment according to FIGS. 12 to 15 ultrasonic waves 8 run through the support means 2 in the width direction (x direction) over a width w, w′ of the support means 2. In that case an entire-width ultrasonic transmission or a part-width ultrasonic transmission of the support means 2 can take place. For a entire-width ultrasonic transmission according to FIGS. 12 and 15 the ultrasonic transmitter 8.1 and/or the ultrasonic receiver 8.2 is or are arranged at the support means 2 either in stationary position or to be mobile. According to FIGS. 12 and 15 the ultrasonic transmitter 8.1 and the ultrasonic receiver 8.2 are arranged at the same longitudinal sides (FIG. 15) or at different longitudinal sides (FIG. 12). Ultrasonic waves 8 coupled into the support means 2 are reflected not only at the longitudinal and wide sides of the support means 2, but also at possible disturbance locations within the support means 2 and, in particular, in disturbance locations within the tensile carriers 2.1. The transit time of the coupled-in and detected ultrasonic waves 8 accordingly shorten in surface regions under which such disturbance locations are present. The evaluating device 8.3 can therefore detect disturbance locations and thus a material state of the support means 2. The entire width w of the support means 2 is checked, i.e. the ultrasonic transmitter 8.1 couples ultrasonic waves 8, which are detected by the ultrasonic receiver 8.2 and locally resolved, over the entire width w of the support means 2. Thus, different transit times over the width w of the support means 2 can be detected in the evaluating device 8.3 and give a conclusion about locally different disturbance locations, particularly in the tensile carriers 2.1, but also in the interior of the synthetic material body 2.2.

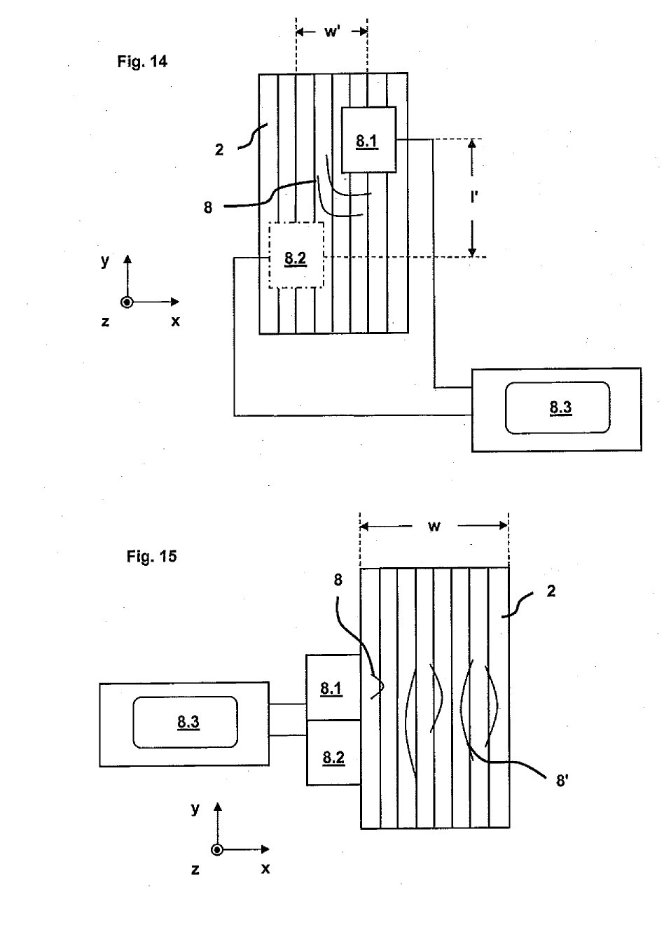

In the forms of embodiment according to FIGS. 13 and 14, ultrasonic waves 8 run through the support means 2 in the longitudinal and the width direction in the xy plane over a length l′ and a width w′. For that purpose the ultrasonic transmitter 8.1 and/or the ultrasonic receiver 8.2 are arranged either in stationary position or to be mobile on the same wide sides (FIG. 13) or on different wide sides (FIG. 14) of the support means 2.

In the form of embodiment according to FIG. 15 the ultrasonic transmitter 8.1 and the ultrasonic receiver 8.2 are arranged at the same longitudinal side of the support means 2. Ultrasonic waves 8 coupled into the support means 2 by the ultrasonic transmitter 8.1 are reflected in the support means 2 and these reflected ultrasonic waves 8′ are detected by the ultrasonic receiver 8.2.

The ultrasonic transmitter 8.1 and the ultrasonic receiver 8.2 are arranged at the same wide side of the support means 2 and run through the thickness d of the support means 2 entirely similarly in the form of embodiment according to FIG. 16. Ultrasonic waves 8 coupled into the support means 2 or generated in the support means 2 by the ultrasonic transmitter 8.1 are reflected in the support means 2 and these reflected ultrasonic waves 8′ are detected by the ultrasonic receiver 8.2. The thickness of the support means 2 reduces with increasing wear. Thus, the transit time between the coupled-in and the received waves transversely to the longitudinal direction also reduces. The evaluating unit 8.3 can determine therefrom a decrease in the material thickness and thus a wear state of the support means 2. In order to constantly ensure sufficient contact with the support means 2, the ultrasonic transmitter 8.1 and the ultrasonic receiver 8.2 are resiliently biased against the support means 2.

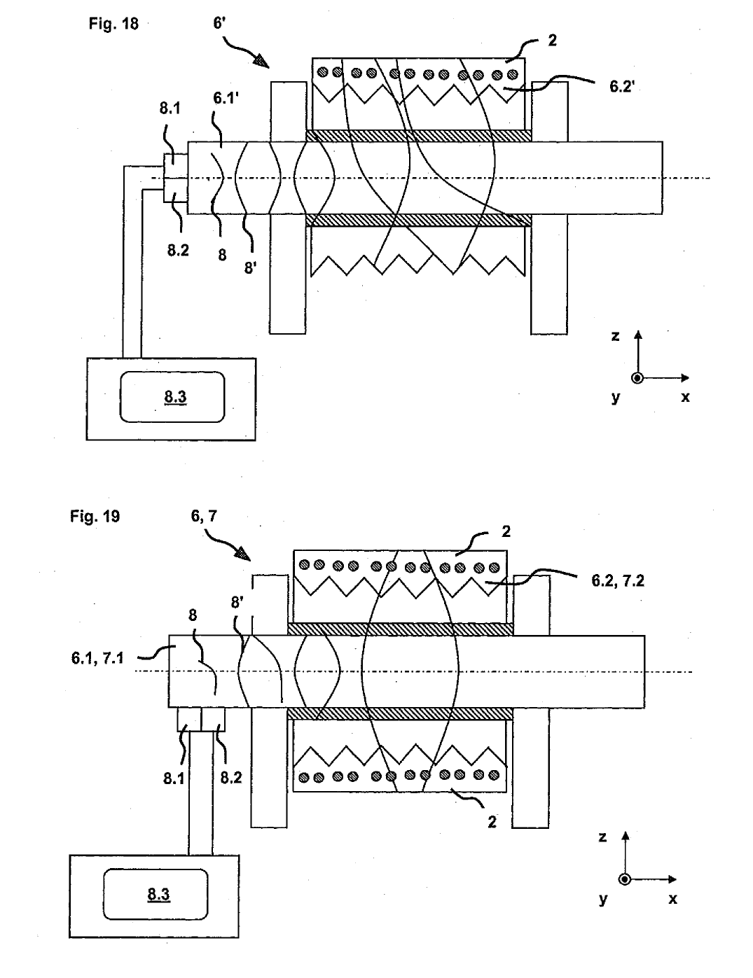

In the forms of embodiment according to FIGS. 17 to 19 a stationarily fixed ultrasonic transmitter 8.1 and ultrasonic receiver 8.2 are clamped against an end face of an axle 6.1 of a deflecting roller 6 or an axle 7.1 of a drive roller 7 or an axle 6.1′ of a deflecting roller 6′. The ultrasonic transmitter 8.1 couples ultrasonic waves 8 in the longitudinal direction of the axle 6.1, 6.1′, 7.1 or generates ultrasonic waves 8 in the longitudinal direction of the axle 6.1, 6.1′, 7.1. The ultrasonic waves 8 propagate from the axle 6.1, 6.1′, 7.1 into a roller body 6.2, 6.2′ or a drive roller body 7.2. The ultrasonic waves 8 are reflected at the support means 2 and the reflected ultrasonic waves 8′ are detected by the ultrasonic receiver 8.2. In the form of embodiment according to Fig, 17, reflected ultrasonic waves 8′ are detected from a support means 2 looping around the deflecting roller 6 or the drive roller 7 by an angle of about 180°. In the form of embodiment according to FIG. 18, reflected ultrasonic waves 8′ are detected from a support means 2 looping around the deflecting roller 6′ at an angle of about 90°.

Finally, in the form of embodiment according to FIG. 19 a stationarily fixed ultrasonic transmitter 8.1 and ultrasonic receiver 8.2 are against a longitudinal side of an axle 6.1 of the deflecting roller 6 or an axle 7.1 of a drive roller 7. The ultrasonic transmitter 8.1 couples ultrasonic waves 8 into the axle 6.1, 7.1 or generates ultrasonic waves 8 in the axle 6.1, 7.1. The ultrasonic waves 8 propagate from the axle 6.1, 7.1 into the roller body 6.2 or the drive roller body 7.2. The ultrasonic waves 8 are reflected at the support means 2 and the reflected ultrasonic waves 8′ are detected by the ultrasonic receiver 8.2.

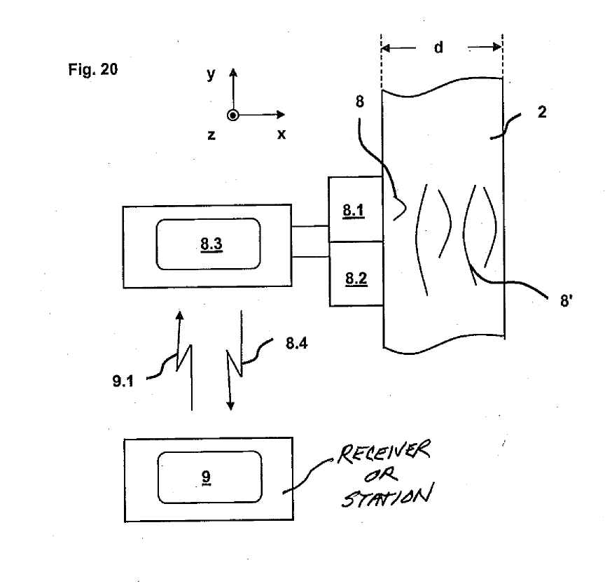

In the case of the detecting device with stationarily mounted ultrasonic transmitter 8.1 and ultrasonic receiver 8.2 the state of the support means 2 can be periodically detected and automatically reported to the central station if a more accurate checking is required. However, it is also possible with the defecting device with stationarily mounted ultrasonic transmitter 8.1 and ultrasonic receiver 8.2 to remotely trigger a measurement. As shown in the form of embodiment according to FIG. 20, a mobile receiver or a central station 9 transmits at least one trigger signal 9.1 to the evaluating device 8.3, in which a corresponding receiver receives the trigger signal 9.1, thereupon activates the ultrasonic transmitter 8.1 and ultrasonic receiver 8.2 and sends back at least one evaluating signal 8.4, for example on the basis of the transit time of the ultrasonic waves 8, 8′, to the mobile receiver or the central station 9. The transmission of the trigger signal 9.1 and the evaluating signal 8.4 takes place by way of fixed mains conducting or, as shown by way of example in FIG. 20, by way of radio,

Neither the support means 2 nor the guidance thereof or the concrete design and arrangement of the ultrasonic transmitter 8.1 or ultrasonic receiver 8.2 in the afore-described forms of embodiment restricts the subject of the present invention. Rather, with knowledge of the invention other forms of embodiment, particularly support means which comprise several support belts, other support means guides and other ultrasonic transmitters or ultrasonic receivers are also possible.

In accordance with the provisions of the patent statutes, the present invention has been described in what is considered to represent its preferred embodiment. However, it should be noted that the invention can be practiced otherwise than as specifically illustrated and described without departing from its spirit or scope.

1-23. (canceled)

24. An elevator system with an elevator car, a support means for holding and moving the elevator car and a detecting device for detecting a state of the support means, the detecting device comprising:
an ultrasonic transmitter for generating ultrasonic waves directly or indirectly in the support means; and
an ultrasonic receiver for detecting the ultrasonic waves propagating in the support means, the detected ultrasonic waves representing the state of the support means.

25. The elevator system according to claim 24 wherein said ultrasonic receiver detects at least one of transmission of the ultrasonic waves in the support means and reflected ultrasonic waves in the support means.

26. The elevator system according to claim 24 wherein the ultrasonic waves have a frequency in a range between 20 kHz and 1 GHz.

27. The elevator system according to claim 24 wherein the ultrasonic waves have a frequency of approximately 75 kHz.

28. The elevator system according to claim 24 wherein said ultrasonic transmitter generates the ultrasonic waves as continuous sound or as impulse sound.

29. The elevator system according to claim 24 wherein said ultrasonic transmitter and said ultrasonic receiver each include at least one of a piezoelectric transducer and an electromagnetic-acoustic transducer.

30. The elevator system according to claim 24 wherein said ultrasonic transmitter generates the ultrasonic waves in at least one of a longitudinal direction of the support means and a width direction of the support means.

31. The elevator system according to claim 24 wherein the support means includes a support belt with tensile carriers for transmission of longitudinal forces, the tensile carriers being arranged at least partly a support belt body of the support belt.

32. The elevator according to claim 24 wherein the support means includes strands of steel.

33. The elevator system according to claim 24 wherein at least one of said ultrasonic transmitter and said ultrasonic receiver is arranged in a stationary position at the support means.

34. The elevator system according to claim 33 wherein said at least one of said ultrasonic transmitter and said ultrasonic receiver is arranged at a fixing point of the support means.

35. The elevator system according to claim 24 wherein at least one of said ultrasonic transmitter and said ultrasonic receiver is mobile relative to the support means.

36. The elevator system according to claim 24 wherein at least one of said ultrasonic transmitter and said ultrasonic receiver is connected directly at the support means.

37. The elevator system according to claim 24 wherein at least one of said ultrasonic transmitter and said ultrasonic receiver is coupled indirectly to the support means.

38. The elevator system according to claim 37 wherein said at least one of said ultrasonic transmitter and said ultrasonic receiver is arranged at an axis of one of a deflecting roller and a drive roller.

39. The elevator system according to claim 24 including an evaluating device connected to said ultrasonic transmitter and said ultrasonic receiver for evaluating the ultrasonic waves detected by said ultrasonic receiver by at least one of: a) detecting a transit time between said ultrasonic transmitter and said ultrasonic receiver; b) detecting an energy decrease of the ultrasonic waves propagated through the support means; and c) detecting a frequency difference between the generated ultrasonic waves and the detected ultrasonic waves.

40. The elevator system according to claim 39 wherein said evaluating device includes at least one of a transmission device for transmission of an evaluating signal and an indicating device for indicating an evaluating signal.

41. The elevator system according to claim 40 wherein said transmission device includes a receiver for reception of a trigger signal and for transmission of the evaluating signal as a reaction to the reception of the trigger signal.

42. The elevator system according to claim 24 wherein the detected state of the support means is at least one of a material state, a wear state, a damage state, a strength state, a tension state, a change state and an inspection state.

43. A method for detecting a state of a support means of an elevator system, comprising the steps:
a. providing an ultrasonic transmitter for generating ultrasonic waves directly or indirectly in the support means; and
b. detecting the ultrasonic waves in the support means with an ultrasonic receiver wherein the detected ultrasonic waves represent the state of the support means.

44. The method according to claim 43 including detecting the state of the support means constantly or at predetermined time intervals,

45. The method according to claim 43 including transmitting a trigger signal to the ultrasonic receiver and receiving and processing an evaluating signal transmitted by the ultrasonic receiver outside an elevator shaft of the elevator system.

46. An apparatus for detecting a state of an elevator car support means comprising:
an ultrasonic transmitter for generating ultrasonic waves; and
an ultrasonic receiver for detecting the ultrasonic waves after propagation through the support means wherein said ultrasonic transmitter and said ultrasonic receiver each are connected directly or indirectly to the support means.

47. The apparatus according to claim 46 wherein said ultrasonic transmitter and said ultrasonic receiver each include a piezoelectric transducer or an electromagnetic-acoustic transducer.
